(19) United States
(12) Patent Application Publication
(10) Pub. No.: US 2014/0164581 A1
(43) Pub. Date: Jun. 12, 2014

(54) Dispersed Storage System with Firewall

(71) Applicant: TRANSPARENT IO, INC., Woodinville, WA (US)

(72) Inventors: Charles Edward Park, Redmond, WA (US); John Aaron Strange, Ft. Collins, CO (US); Robert Pike, Woodinville, WA (US)

(73) Assignee: TRANSPARENT IO, INC., Woodinville, WA (US)

(21) Appl. No.: 13/709,061

(22) Filed: Dec. 10, 2012

(51) Int. Cl. G06F 11/30; G06F 15/177

(52) U.S. Cl. CPC G06F 11/3048; G06F 15/177
USPC 709/221; 709/223

(57) ABSTRACT

A remotely managed storage system may configure logical units using a low level storage controller on each managed computer system plus a target driver for each shared storage device. The storage controller may present logical units to operating systems running on a computer system and may operate on a lower level than a host operating system or hypervisor. A target driver may allow remote devices to use the local storage devices for other logical units. A storage master may configure the various components across a group of computers to create logical units of storage that are backed by multiple storage devices.

### BACKGROUND

Storage devices may be shared in a dispersed storage system. Storage devices, such as disk drives and other storage media, may be used to store data for multiple logical units. For example, a hard disk may be configured with three block extents. Each of the block extents may be assigned to different logical units, and each logical unit may be used by a separate guest operating system in a virtual machine environment that may be managed by a host operating system or hypervisor.

In such a configuration, a hard disk may store data that may be owned by different operating systems. It may be possible for an application on the host operating system to access the storage space of one of the guest operating systems. Such access may be intentional or unintentional, but the consequences may be a breach of security for the guest operating system.

### SUMMARY

A remotely managed storage system may configure logical units using a low level storage controller on each managed computer system plus a target driver for each shared storage device. The storage controller may present logical units to operating systems running on a computer system and may operate on a lower level than a host operating system or hypervisor. A target driver may allow remote devices to use the local storage devices for other logical units. A storage master may configure the various components across a group of computers to create logical units of storage that are backed by multiple storage devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a computer system with a storage management system.

FIG. 2 is a diagram illustration of an embodiment showing a device with managed storage and several logical units.

FIG. 3 is a flowchart illustration of an embodiment showing a method for provisioning storage devices for a logical unit.

FIG. 4 is a flowchart illustration of an embodiment showing a method for configuring a logical unit for an image.

FIG. 5 is a flowchart illustration of an embodiment showing a method for processing read requests.

### DETAILED DESCRIPTION

A storage management system configure logical units across a group of computers, each of the computers may have several storage devices. The management system may use storage managers that provide logical units to a local operating system and target drivers that provide storage for use by other computers.

The logical units may be backed by storage on the local device as well as storage on other devices. In many cases, a single logical unit may have block extents that are duplicated on other storage devices and on other computer systems. The logical units may behave as single storage devices to an operating system, yet the storage may be provided by multiple devices. In many cases, the multiple devices may be used to store data redundantly, as well as for performance benefits.

The storage managers may create logical units that are provided to local operating systems, including a host operating system. The storage managers may be lower on the software stack than the host operating system, such that the host operating system may not be able to access storage on the computer system that is not allocated specifically to the host operating system.

The target drivers may manage external access to storage devices on a given computer system. When configured, a target driver may permit a remote device to access a block extent on a storage device attached to the computer system. In many cases, a storage manager on the remote system may access the block extent and provide a logical unit to an operating system on the remote system.

A master controller may create a topology of logical units and configure the storage system components to match the topology. The components may include the storage managers and target drivers on the various computer systems. The topology may be transmitted to the components through a dispatcher that may be able to configure the components while the components are operating.

Because the storage manager and target drives may operate below the operating system, the various operating systems may not be able to access the storage devices directly. This may eliminate the possibility that intentional or unintentional security breaches may occur when one application or user on one operating system may access storage associated with a different operating systems. Such security may be useful in a multiple hosted environment where different customers may use the same hardware simultaneously.

The storage management system may present a single logical unit while providing the logical unit on a plurality of devices. The storage management system may maintain a service level agreement by configuring the devices in different manners and placing blocks of data on different devices.

The storage management system may manage storage devices that may include direct attached storage devices, such as hard disk drives connected through various interfaces, solid state disk drives, volatile memory storage, and other media including optical storage and other magnetic storage media. The storage devices may also include storage available over a network, including network attached storage, storage area networks, and other storage devices accessed over a network.

Each storage device may be characterized using parameters similar to or derivable from a service level agreement. The device characterizations may be used to select and deploy devices to create logical units, as well as to modify the devices supporting an existing logical unit after deployment.

The service level agreement may identify minimum performance characteristics or other parameters that may be used to configure and manage a logical unit. The service level agreement may include performance metrics, such as number of input/output operations per unit time, latency of operations, bandwidth or throughput of operations, and other performance metrics. In some cases, a service level agreement may include optimizing parameters, such as preferring devices having lower cost or lower power consumption than other devices.

The service level agreement may include replication criteria, which may define a minimum number of different devices to store a given block. The replication criteria may identify certain types of storage devices to include or exclude.

The storage management system may receive a desired size of a logical unit along with a desired service level agreement. The storage management system may identify a group of available devices that may meet the service level agreement and provision the logical unit using the available devices.

During operation of the logical unit, the storage management system may identify when the service level agreement may be exceeded. The storage management system may reconfigure the provisioned devices in many different manners, for example by converting from synchronous to asynchronous write operations or striping read operations. In some cases, the storage management system may add or remove devices from supporting the logical unit, as well as moving blocks from one device to another to increase performance or otherwise meet the storage level agreement.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

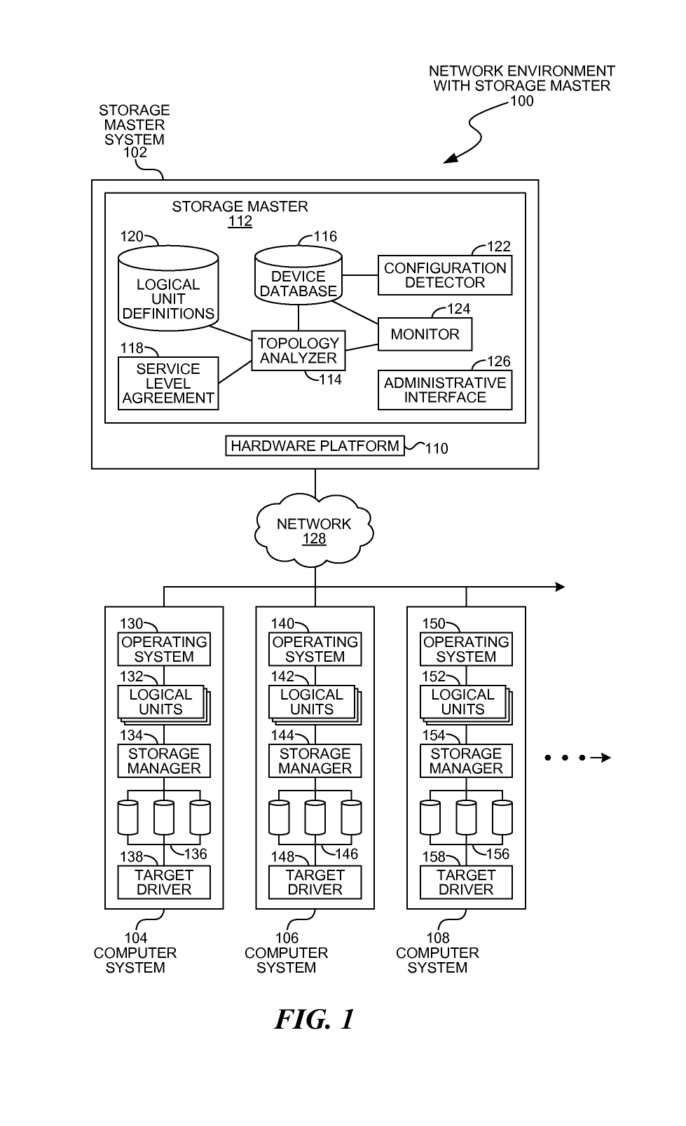

FIG. 1 is a diagram of an embodiment 100 showing a network environment with a storage master. Embodiment 100 is a functional diagram showing a storage master system 102 and several computer systems 104, 106, and 108. Each of the computer systems may be configurable to present logical units to operating systems on the respective systems.

The storage master system 102 may manage the various computer systems 104, 106, and 108 by configuring storage for each system. In some cases, storage devices on one computer may be used by a logical unit on another computer. Such cases may be useful to maintain a separate copy of a logical unit or portion of a logical unit on another device in the case of failure of the original device. In some cases, multiple storage devices may be used in a striped configuration that may increase performance for some operations.

The ability to use storage on other devices may also enable scenarios where excess storage on one computer may be used by another computer that may not have enough storage. In such cases, excess storage on one device may be made available through a target driver to another device, which may add the new storage to a logical unit.

The storage master system 102 may configure the various computer systems 104, 106, and 108 to create and manage logical units. The storage master system 102 may determine a topology for many logical units given that various storage devices available, the service level agreement, and other factors. Once the topology is defined, the storage manager 102 may configure the computer systems.

The storage master system 102 may update or change the logical unit topology over time. For example, one logical unit may run out of available space. In such a case, the storage master system 102 may identify additional storage space on one of the many storage devices and allocate that storage space to the logical unit. Such a situation may occur when the logical unit may be thinly provisioned, which may mean that the logical or addressable space in a logical unit may be larger than the amount of storage allocated to the logical unit. As the logical unit uses the allocated space, the storage master 102 may allocate additional space.

The storage master system 102 may change the topology when a service level agreement is not being met. For example, a logical unit's performance may suffer because one of the storage devices begins to experience poor performance, which may trigger a breach of the service level agreement. The breach may cause the storage master system 102 to identify a replacement device for the poor performing device, then cause the logical unit to be reconfigured to use the replacement device and deallocate the poor performing device.

The storage master system 102 may execute on a hardware platform 110, which may be any computing platform. In a typical embodiment, the hardware platform 110 may be a conventional computing system with a processor, random access memory, nonvolatile memory, user interfaces, network interfaces, and other components. In embodiment 100, the storage master system 102 is illustrated as a single device, but in other embodiments, different functions may be contained in separate devices.

The storage master 112 may be a software application that performs the management and monitoring functions for the logical units that may operate on the computer systems 104, 106, and 108.

The storage master 112 may have a topology analyzer 114 which may determine the storage allocation for each logical unit. Each logical unit may be assigned block extents contained on specific storage devices. The topology analyzer 114 may take into account a set of logical unit definitions 120 and a service level agreement 118 when creating the topology.

The logical unit definitions 120 may define the logical units that are to be presented on each of the managed computer systems. The logical unit definitions 120 may define the size, content, or other descriptors of each logical unit.

The service level agreement 118 may define a set of static and dynamic parameters for a logical unit or for data stored in the logical unit. In some cases, a service level agreement may define that one type of data or file may be stored in one manner while another type of data or file may be stored in a different manner.

For example, a service level agreement 118 may define that application executable files may be stored in one location, while application data may be stored in at least two locations. In some cases, data that is replicated on two devices may be configured to be on the same device and used for striping access, while in other cases data may be replicated on two devices for fault tolerance.

The topology analyzer 114 may take into consideration all of the available storage devices, which may be stored in a device database 116. The device database 116 may be populated by a configuration detector 122 that may query all of the available devices to determine their storage capacity, network topology, and other aspects. In some cases, the configuration detector 122 may perform active performance tests or passively monitor device performance. Such data may be useful in cases where the service level agreement 118 may define performance metrics for a logical unit or data within a logical unit.

A monitor 124 may track performance of a logical unit, storage device, or other factors. The monitor 124 may collect data that may be evaluated against the service level agreement 118 to determine when the service level agreement 118 has been breached. The monitor 124 may also collect performance data that may be stored in the device database 116.

An administrative interface 126 may be a user interface through which an administrator may create or modify the logical unit definitions 120, the service level agreement 118, or perform other administrative functions. In some cases, an administrator may be able to override settings or manually configure a logical unit, as well as monitor performance of the various devices and logical units.

The computer systems 104, 106, and 108 represent several computers that may be managed by the storage master system 102. In many embodiments, such as in a large datacenter, the storage master system 102 may manage several hundreds or even thousands of computer systems.

A network 128 is illustrated as connecting the various devices. In some embodiments, multiple networks 128 may be used. For example, a high speed, high bandwidth storage network may connect the various computer systems together and a separate, lower speed communications network may be used to configure the various systems. In some cases, some storage devices may be configured to communicate across one type of network while other storage devices may be configured to communicate across a different network.

Computer system 104 is illustrated as having an operating system 130, one or more logical units 132, a storage manager 134, one or more storage devices 136, and a target driver 138. Computer system 106 is illustrated as having an operating system 140, one or more logical units 142, a storage manager 144, one or more storage devices 146, and a target driver 148. Similarly, computer system 108 is illustrated as having an operating system 150, one or more logical units 152, a storage manager 154, one or more storage devices 156, and a target driver 158.

The storage managers may present logical units to the respective operating systems. The storage managers may operate at a layer below the host operating system and may be configured and managed without involving the operating system. With such an architecture, the storage managers may be able to prevent a user or application from accessing storage resources that are not allocated to the operating system in which a user or application may function.

Such an architecture may provide increased separation and security from one logical unit to another. Such security may be useful in a cohosted environment, for example, where multiple users may execute applications on the same hardware platform or where two logical units may be stored on the same device.

The storage managers may be configured with the block extents that make up a logical unit, then manage the logical unit by storing and accessing data within the allocated block extents. A single logical unit may be composed of block extents from one or more local storage devices. In some cases, some or all of the storage for a local logical unit may be provided by remote storage. For example, the logical unit 132 may be stored on the storage devices 146 or 156 of the remote computer systems 106 or 108, respectively.

The target drivers 138, 148, and 158 may be configured to permit network access to block extents on the various storage devices 136, 146, and 156, respectively. The target drivers may have a configuration setting that permits a specified requestor to access a specific block extent. The configuration may be made by the storage master system 102 as part of configuring the various logical units.

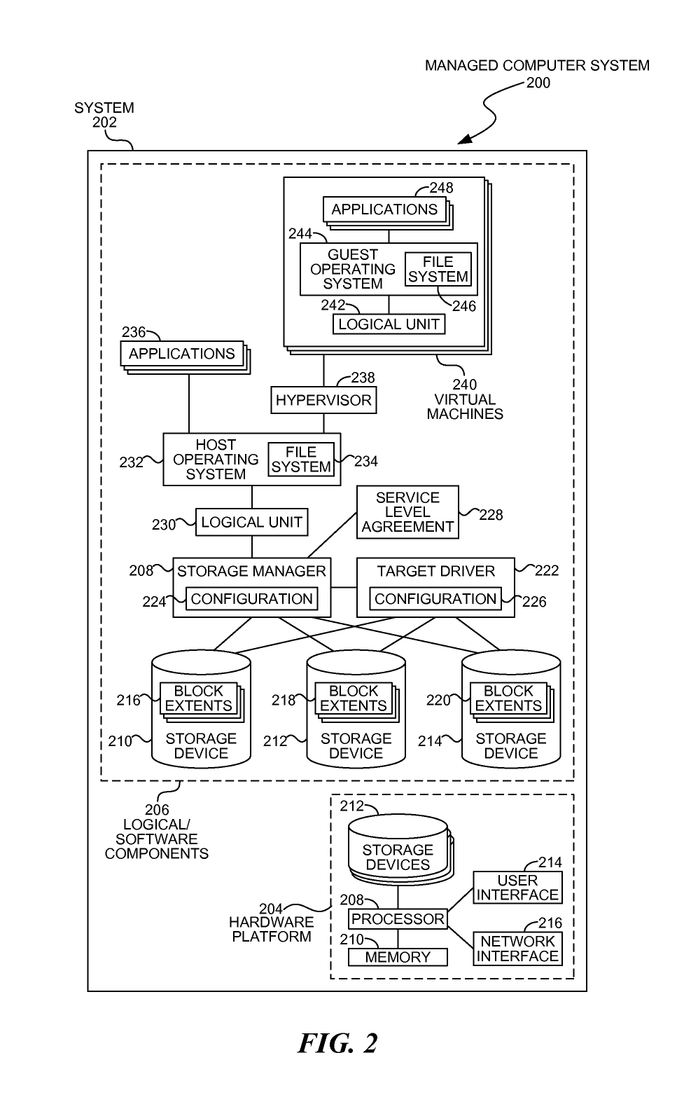

FIG. 2 is a diagram of an embodiment 200 showing a computer system with a storage management system that may store data and files using storage from multiple devices. The system 202 may represent one of the computer systems 104, 106, or 108 from embodiment 100. The system 202 may illustrate how many different logical units may be presented on a single device, and where the logical units may be used for the host operating system as well as guest operating system in a virtual machine architecture.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates an example computer system that may have a storage manager and target driver that may allocate storage on the computer system for locally hosted logical units as well as for remotely hosted logical units. In some cases, a local logical unit may use storage on local storage devices and remote storage devices.

Embodiment 200 illustrates a system 202 that may have a hardware platform 204 and various software components 206. The system 202 as illustrated represents a conventional computing device, although other embodiments may have different configurations, architectures, or components.

In many embodiments, the system 202 may be a server computer. In some embodiments, the system 202 may still also be a desktop computer, laptop computer, netbook computer, tablet or slate computer, wireless handset, cellular telephone, game console or any other type of computing device.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the system 202 is shut down. The nonvolatile storage 212 may be any type of storage device, including hard disk, solid state memory devices, magnetic tape, optical storage, or other type of storage. The nonvolatile storage 212 may be read only or read/write capable.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include a storage manager 208 which may manage the various local storage devices 210, 212, and 214. Each storage device may be configured with block extents 216, 218, and 220, where the block extents may be allocated to different logical units.

The storage manager 208 may present a logical unit 230 to a host operating system 232. The storage manager 208 may operate below the host operating system 232. In many such cases, the storage manger 208 may execute in a bootstrapped environment that creates and manages the logical units, and once the logical units are formed, the host operating system 232 may begin operating.

The storage manager 208 may operate using a service level agreement 228. During operations, the storage manager 208 may evaluate performance and other factors of the various logical units and compare the actual factors against the service level agreement 228. When a breach of the service level agreement 228 has been detected, the storage manager 208 may be capable of reconfiguring the logical unit to meet the service level agreement 228. In some embodiments, the storage manager 208 may detect a breach of the service level agreement 228, then notify a storage master system. The storage master system may then transmit changes to the logical units to the storage manager 208.

The storage manager 208 may have a configuration 224, and in a similar fashion, the target driver 222 may have a configuration 226. The configurations 224 and 226 may be settings that define how the storage manager 208 and target driver 22 may respectively behave. The configurations may be defined by a remote storage master system and transmitted to the system 202.

The host operating system 232 may have a file system 234 and may execute various applications 236. The host operating system 232 may use the storage within the logical unit 230 and may treat the logical unit 230 as a single storage device, such as a hard disk or other storage media, even though the storage manager 208 may actually store the information on one or more different devices.

A hypervisor 238 may operate within the host operating system 232 and support multiple virtual machines 240. In some embodiments, a hypervisor may run directly on the logical unit 230 in place of the host operating system 232.

The virtual machines 240 may have a logical unit 242 on which a guest operating system 244 and file system 246 may operate. The guest operating system 244 may execute various applications 248. The logical units 242 may be provided and managed by the storage manager 208.

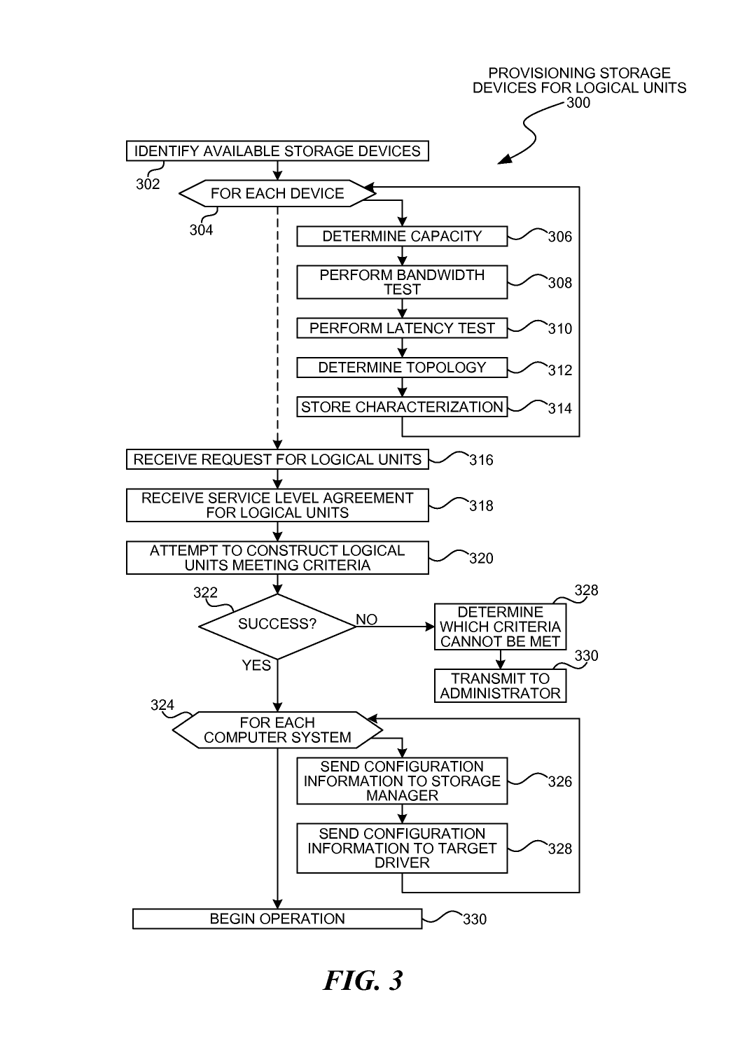

FIG. 3 is a flowchart illustration of an embodiment 300 showing a method for provisioning storage devices for logical units. Embodiment 300 illustrates one method by which a service level agreement may be used to configure and deploy a topology of logical units after gathering metadata about the available storage devices.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 302, all of the available storage devices may be identified. In some embodiments, a crawler or other automated component may detect and identify local and remotely attached storage devices. In some embodiments, a user may identify various storage devices to the system. Such embodiments may be useful when remotely available storage devices may not be readily accessible or identifiable to a crawler mechanism.

For each device in block 304, the capacity may be determined in block 306. The capacity may include the amount of raw storage that may be available on the device.

A bandwidth test may be performed in block 308 to determine the burst and sustained rate of data transfer to and from the device. Similarly, a latency test may be performed in block 310 to determine any initial or sustained latency in communication with the storage device. In some embodiments, the bandwidth and latency tests may be a dynamic performance test, where the communication to the device may be exercised. In some embodiments, the bandwidth and latency may be determined by determining the type of interface to the device and deriving expected performance parameters.

A dynamic performance test may be useful when a storage device may be accessed through a network or other connection. In such cases, the network connections may add performance barriers that may not be determinable through a static analysis of the connections.

The topology of the device may be determined in block 312. The topology may define the connections from a logic unit to the storage device. The topology may include whether or not the device may be local to the intended computing device. For remotely located devices, the topology may include whether the device is in the same or different rack, the same or different local area network, the same or different datacenter or other geographic location.

In many embodiments, a service level agreement may enforce a duplication parameter where duplicates of each block may be stored in various remote locations. For example, a service level agreement may define that a copy of all blocks be stored in a datacenter within a specific country but remote from the device accessing the logical unit.

The topology may also define the block sizes possible for each device. In some devices, the block size may be determined when the device is initially formatted and may not be changed thereafter. Other devices may have unformatted portions of storage that a storage manager may subsequently format using a specific block size.

After determining the topology and other metadata about the storage devices, the characterization of the storage devices may be stored in block 314.

A request for a group of logical units may be received in block 316. The service level agreement may be received in block 318 for the logical units.

In block 320, an attempt to construct all of the logical units may be made according to the service level agreement. The logical unit may be constructed by first identifying storage devices that may meet the performance metrics defined in a service level agreement. In some cases, the performance metrics may be met by combining two or more storage devices together, such as striping devices to increase read performance.

The service level agreement may define that several replications of specific block extents, files, or complete logical units be implemented. In many such cases, one of the replications may be a remote device. The service level agreement may define that write operations be performed synchronously across the group of storage devices. The storage manager may monitor the write operations and may reconfigure the devices supporting a logical unit when the performance of the logical unit falls below a predefined standard. In such cases, the storage manager may change from synchronous write operations to asynchronous write operations on a temporary basis and revert to synchronous write operations when able.

Once the performance and other metrics may be met, the storage capacity of a logical unit may be attempted to be met by provisioning the storage devices. In some cases, the provisioning may be thin provisioning, where the full physical storage capacity may not be assigned or provisioned, and where the full physical storage capacity may or may not be available at the time the storage is provisioned.

The provisioning exercise in block 320 may include provisioning specific storage devices with specific block extents for storage.

If the storage management system determines that the service level agreement may not be met in block 322 and result in a successful provisioning, the criteria that may not be met may be determined in block 328. These criteria may be presented to an administrator in block 330, and the administrator may elect to change the criteria or make other changes to the system to meet the criteria. In some cases, the administrator may add more storage devices to the available storage devices to meet the deficiencies identified in block 328.

If the storage management system has determined that a logical unit topology may be provisioned with success in block 322, a dispatcher may be used to configure the systems. For each computer system in block 324, configuration information may be sent to the storage manager in block 326 and to the target driver in block 328. After provisioning all of the computer systems, the system may begin operation in block 330.

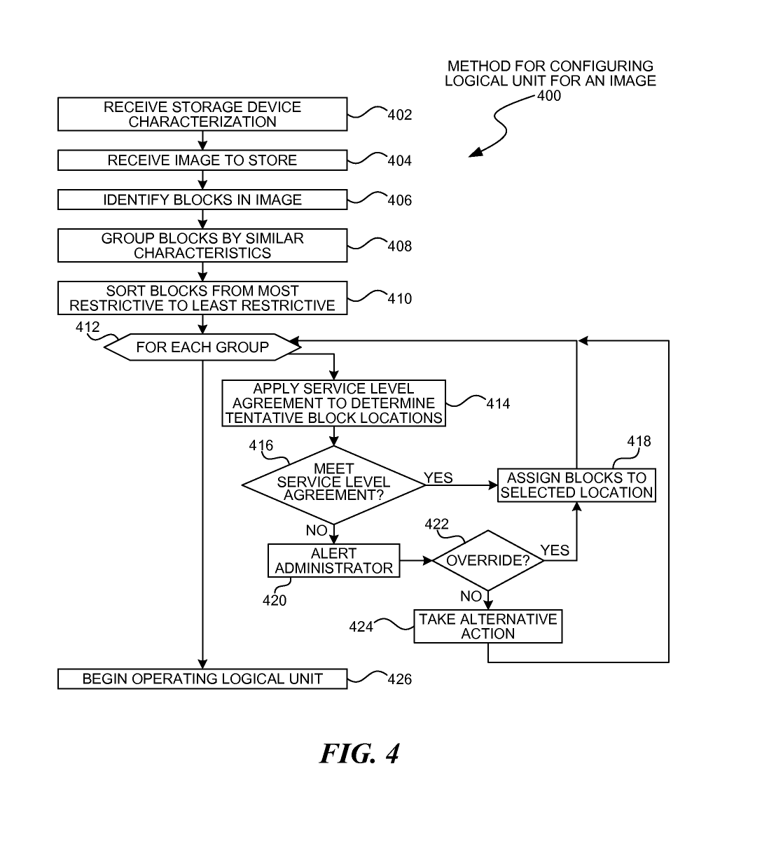

FIG. 4 is a flowchart illustration of an embodiment 400 showing a method for configuring a logical unit for a given image. Embodiment 400 illustrates one method by which blocks in an image may be examined and placed on a set of available storage devices to best meet a service level agreement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Once a logical unit been configured, the logical unit may be loaded with disk images. The images may represent the initial state of a logical unit.

The characterizations of available storage devices may be received in block 402. The characterizations may define the capabilities, performance, and other parameters about the available storage devices.

An image may be received in block 404. An image may include all of the blocks for a logical unit, which may be identified in block 406. The image may contain blocks with different tags that define how the block may be classified and used.

The blocks may be grouped in block 408 by similar characteristics, and sorted in block 410 from the most restrictive to the least restrictive. Each group of blocks may be processed in block 412.

For each group of blocks in block 412, a service level agreement may be applied to identify tentative locations for the block. The service level agreement may define the desired block size for storage, along with performance, number of copies of blocks, and other parameters. In many cases, the service level agreement may define one set of parameters for one type of block and another set of parameters for another type of block. As such, each group of blocks may be treated differently by the service level agreement.

If the tentative placement of the blocks meets the service level agreement in block 416, the blocks may be assigned to the selected location in block 418. If the service level agreement is not met in block 416, an administrator may be alerted in block 420. The administrator may elect to override the service level agreement in block 422, in which case the blocks may be placed according to the selected location in block 418. Otherwise, the administrator may take alternative action in block 424, which may be to add more storage devices, change the placement of the logical unit, or other action.

Once each group is placed on the storage devices, the logical unit may begin operation in block 426.

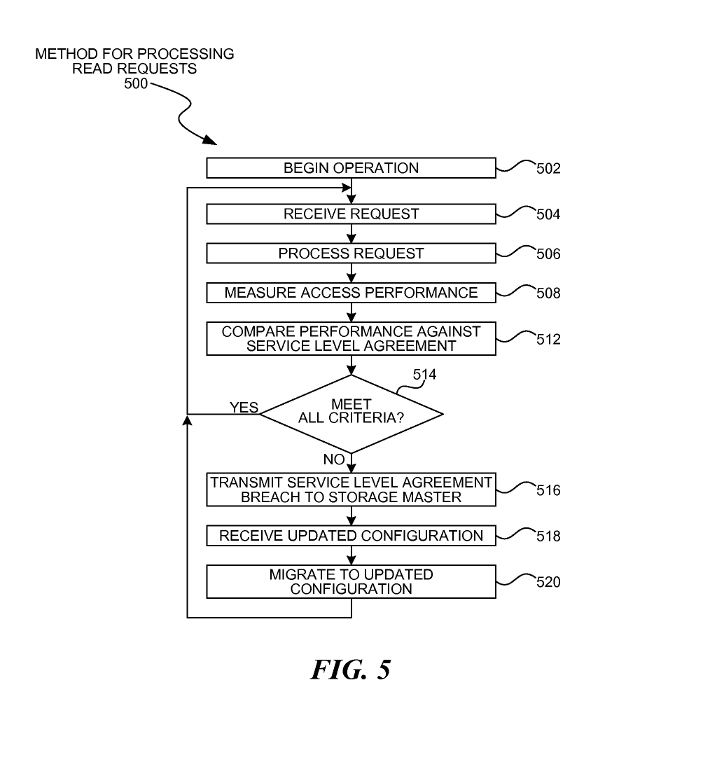

FIG. 5 is a flowchart illustration of an embodiment 500 showing a method for operating a logical unit and specifically processing a read request. Embodiment 500 illustrates how the service level agreement may be used to identify storage blocks that may be reconfigured to meet a service level agreement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A logical unit may begin operation in block 502. As part of normal operation, the logical unit may receive a request, which may be a read request, in block 504. The request may be processed in block 506.

During the operation, a storage manager may measure access performance of the system in block 508. The actual or measured performance may be compared against the service level agreement in block 512. If the service level agreement is met in block 514, the process may return to block 504 to process additional requests. If the service level agreement is not met in block 514, a message may be sent to a storage master in block 516. The storage master may determine an updated logical unit topology, which may result in receiving an updated configuration in block 518. Once the updated configuration is received, the storage manager may migrate to the new configuration in block 520.

The migration in block 520 may move blocks from one storage device to another device that may have increased or decreased performance. In some instances, the reconfiguration may be to move blocks from one block extent to another block extent. When the block extents have different block sizes, the system may convert from one block size to another for storage.

For example, a block that may be accessed infrequently may be moved to a slower performing storage device, while a block that may be accessed very frequently may be moved to a higher performing storage device.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
determining a logical unit topology comprising a plurality of logical units, each of said logical units being stored on a plurality of storage devices, said logical unit topology being compliant with a service level agreement;
said topology comprising a plurality of computer systems, each of said plurality of computer systems having at least one of said storage devices;
for a first computer system, determining a first set of logical units to be available for an operating system on said computer system and configuring a storage manager on said computer system to provide said first set of logical units; and
for said first computer system, determining a second set of logical units to be available over a network connection and configuring a first target driver on said first computer system with said logical units.

2. The method of claim 1, said storage manager being further configured to provide a first logical unit for a host operating system on said first computer system.

3. The method of claim 2, said storage manager being further configured to provide a second logical unit for a guest operating system on said first computer system.

4. The method of claim 3, said storage manager providing said first set of logical units by allocating a plurality of block extents on storage devices attached to said first computer system.

5. The method of claim 4, said storage manager preventing said host operating system from accessing a block extent associated with said second logical unit.

6. The method of claim 2 further comprising:
for a second computer system, determining that said first logical unit is provided at least in part by a first storage device on a second computer system; and
configuring a second target driver on said second computer system to provide storage for said first logical unit.

7. The method of claim 6, said storage manager managing said first set of logical units according to said service level agreement.

8. The method of claim 7, said storage manager determining that said service level agreement is not being met and reconfiguring said first logical unit.

9. The method of claim 8, said reconfiguring comprising moving a first block extent from a first storage device to a second storage device.

10. The method of claim 9, said first storage device being a local storage device to said first computer system and said second storage device being a local storage device to said second computer system.

11. The method of claim 10, said reconfiguring comprising:
receiving a reconfiguration request when said service level agreement is not being met;
determining an updated logical unit topology; and
communicating with at least one storage manager and at least one target driver to reconfigure said first logical unit.

12. A system comprising:
a processor;
a storage master operating on said processor, said storage master having:
a dispatcher in communication with a plurality of computer systems, each of said computer systems having a storage manager and a target driver, each of said computer systems further having at least one storage device;
a topology analyzer that:
receives a set of logical units to define;
receives a storage device topology defining said computer systems and storage devices connected to said computer systems;
determines a logical unit topology based on said set of logical units and said storage device topology;
determines a configuration for each of said storage managers and target drivers to meet said logical unit topology; and
causes said dispatcher to configure said storage managers and said target drivers according to said logical unit topology.

13. The system of claim 12, said topology analyzer that further:
determines said logical unit topology according to a service level agreement.

14. The system of claim 13, said topology analyzer that further:
determines that said service level agreement is not being met with a first logical unit; and
determines an updated logical unit topology based on said set of logical units, said storage device topology, and said service level agreement; and
causes said dispatcher to configure said storage managers and said target drivers according to said logical unit topology.

15. The system of claim 14, said determining that said service level agreement is not being met being determined by receiving an alert from a first storage manager.

16. The system of claim 14, said determining that said service level agreement is not being met being determined by monitoring performance of a first storage manager.
